(19) United States
(12) Patent Application Publication
(10) Pub. No.: US 2022/0286447 A1
(43) Pub. Date: Sep. 8, 2022

(54) PROVIDING SECURITY SERVICES VIA FEDERATION-BASED NETWORK DURING ROAMING

(71) Applicant: Cisco Technology, Inc., San Jose, CA (US)

(72) Inventors: Robert E. BARTON, Richmond (CA); Jerome HENRY, Pittsboro, NC (US); Nagendra Kumar NAINAR, Morrisville, NC (US); Carlos M. PIGNATARO, Cary, NC (US); Bart A. BRINCKMAN, Nevele (BE)

(21) Appl. No.: 17/249,644

(22) Filed: Mar. 8, 2021

(51) Int. Cl. H04L 29/06

(52) U.S. Cl. CPC H04L 63/0853; H04L 63/0815; H04L 63/0823

(57) ABSTRACT

Aspects described herein include a method and related network device and computer program product. The method includes authenticating an identity of a user of a client device associated with an access network provider. Authenticating the identity of the user includes receiving, from an identity provider, a credential associated with the identity and information identifying a network-based security service to be provided to the client device. The method further includes establishing, using the credential and the received information, a secure connection between the access network provider and a security service provider that is capable of providing the network-based security service to the client device.

### TECHNICAL FIELD

Embodiments presented in this disclosure generally relate to wireless networking, and more specifically, to techniques for providing network-based security services to client devices when roaming.

### BACKGROUND

Consumers increasingly expect their computing devices to remain connected to network-based services, regardless of their location. However, cellular services such as 4G LTE and 5G may provide less than optimal connections for certain locations that are indoors, far from cell towers, and/or otherwise obstructed. Technologies such as the Wireless Broadband Alliance's (WBA) OpenRoaming™ use a federation-based framework to allow consumers to seamlessly roam onto Wi-Fi networks.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a diagram illustrating connection of a client device to a federation-based network while roaming, according to one or more embodiments.

FIG. 2 is a diagram illustrating a sequence for connection of a client device to a federation-based network, according to one or more embodiments.

FIG. 3 is a diagram illustrating accessing a network-based security service, according to one or more embodiments.

FIG. 4 is a method of accessing a network-based security service, according to one or more embodiments.

FIGS. 5A-5F illustrate a sequence of accessing a network-based security service, according to one or more embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method comprising authenticating an identity of a user of a client device associated with an access network provider. Authenticating the identity of the user comprises receiving, from an identity provider, a credential associated with the identity, and receiving, from the identity provider, information identifying a network-based security service to be provided to the client device. The method further comprises establishing, using the credential and the received information, a secure connection between the access network provider and a security service provider that is capable of providing the network-based security service to the client device.

Another embodiment presented in this disclosure is a network device comprising one or more computer processors configured to perform an operation. The operation comprises authenticating an identity of a user of a client device associated with an access network provider. Authenticating the identity of the user comprises receiving, from an identity provider, a credential associated with the identity, and receiving, from the identity provider, information identifying a network-based security service to be provided to the client device. The operation further comprises establishing, using the credential and the received information, a secure connection between the access network provider and a security service provider that is capable of providing the network-based security service to the client device.

Another embodiment presented in this disclosure is a computer program product comprising a computer-readable storage medium having computer-readable program code embodied therewith. The computer-readable program code is executable by one or more computer processors to perform an operation comprising authenticating an identity of a user of a client device associated with an access network provider. Authenticating the identity of the user comprises receiving, from an identity provider, a credential associated with the identity, and receiving, from the identity provider, information identifying a network-based security service to be provided to the client device. The operation further comprises establishing, using the credential and the received information, a secure connection between the access network provider and a security service provider that is capable of providing the network-based security service to the client device.

### Example Embodiments

Technologies such as OpenRoaming™ permit client devices to roam to different access network providers without requiring repeated logins or authentications. Identity providers may seek to offer additional services beyond roaming, such as providing network-based (e.g., cloud-based) security services to the client devices.

In embodiments described herein, a method comprises authenticating an identity of a user of a client device associated with an access network provider. Authenticating the identity of the user comprises receiving, from an identity provider, a credential associated with the identity, as well as information identifying a network-based security service to be provided to the client device. The method further comprises establishing, using the credential and the received information, a secure connection between the access network provider and a security service provider that is capable of providing the network-based security service to the client device.

Beneficially, the method allows users to enable and/or configure network-based security services at an identity provider. The method also enables the automatic, secure connectivity of client devices to third-party security service providers. The method also enables the security service providers to deliver security services that are tailored to the users by accessing the users' security policies configured at the identity provider.

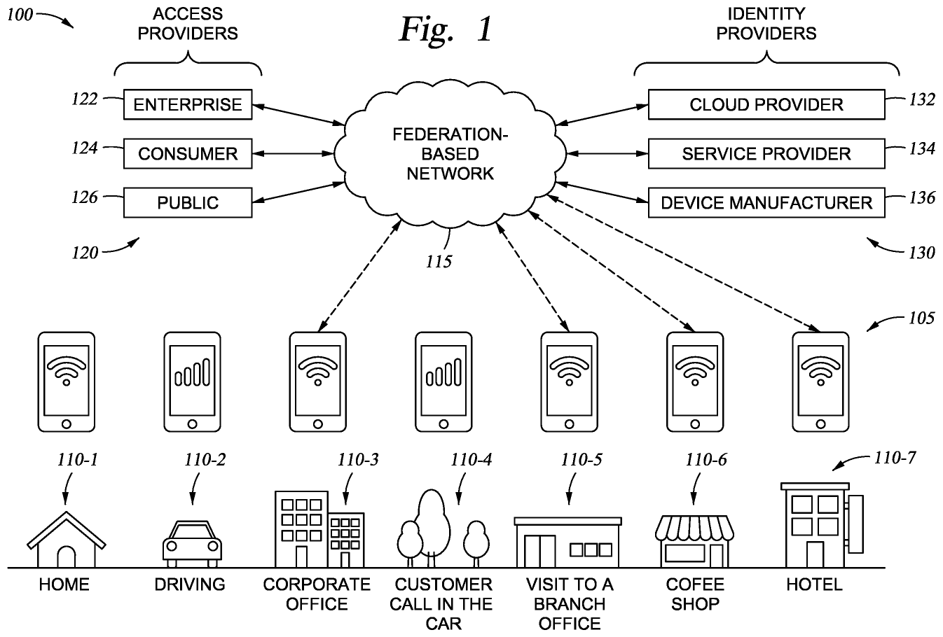

FIG. 1 is a diagram 100 illustrating connections of a client device 105 to a federation-based network 115 while roaming, according to one or more embodiments. The diagram 100 represents an example sequence of usage of a client device 105 by a user. For example, the sequence may represent a work trip of the user.

The client device 105 may be implemented in any form suitable for wireless networking. In some embodiments, the client device 105 is implemented as a mobile computing device, such as a laptop computer, a tablet, a smartphone, or a smart wearable device. In other embodiments, the client device 105 may be a computing device integrated into a vehicle.

At the beginning of the sequence, the user is at home 110-1 and the client device 105 is wirelessly connected to a home network (e.g., a Wi-Fi network) providing accessibility to an external network, such as a local area or local access network (LAN), a general wide area network (WAN), and/or a public network (e.g., the Internet). While the user is driving 110-2 a car, the client device 105 is wirelessly connected to a cellular network, such as a 4G LTE or 5G cellular network. When the user arrives at a corporate office 110-3, the client device 105 roams from the cellular network to a Wi-Fi network operated by the corporate office 110-3. The user returns to the car to conduct a customer call 110-4, and the client device 105 reconnects to the cellular network when out of range of the Wi-Fi network. The client device 105 later roams to different Wi-Fi networks when the user visits a branch office 110-5, a coffee shop 110-6, and a hotel 110-7.

When roaming to the different Wi-Fi networks (e.g., at the corporate office 110-3, the branch office 110-5, the coffee shop 110-6, and the hotel 110-7), the client device 105 uses a federation-based network 115 to access the external network. The federation-based network 115 may be implemented using any standardized and/or proprietary techniques and protocols. For example, the federation-based network 115 may be compliant with OpenRoaming™.

The federation-based network 115 comprises a plurality of access providers 120 (also referred to as “access network providers”) providing wireless connectivity for the client device 105 using, e.g., access points, wireless LAN controllers, and so forth. Some non-limiting examples of the access providers 120 include enterprise access providers 122 (e.g., employers, manufacturing facilities), consumer access providers 124 (e.g., hotels, retailers), public access providers 126 (e.g., airports, universities, venues), and so forth.

The federation-based network 115 comprises a plurality of identity providers 130 that operate to create, maintain, and/or manage identity information for users and that provide authentication services within the federation-based network 115. Some non-limiting examples of the identity providers 130 include cloud providers 132 (e.g., vendors providing scalable computing resources), service providers 134 (e.g., telecommunications companies, utilities), and device manufacturers 136. By using the identity providers 130 to authenticate the user, the client device 105 may roam to the different access providers 120 without requiring repeated logins or authentications from the user.

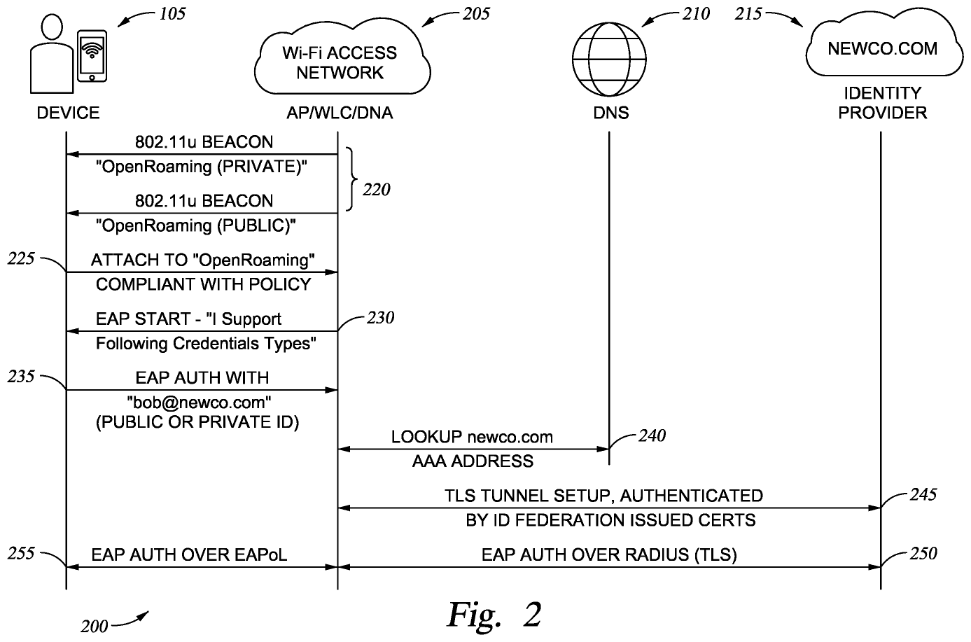

FIG. 2 is a diagram 200 illustrating a sequence for connection of a client device 105 to a federation-based network, according to one or more embodiments. The features illustrated in the diagram 200 may be used in conjunction with other embodiments, for example, illustrating connection of the client device 105 with an access provider 120 at any of the corporate office 110-3, the branch office 110-5, the coffee shop 110-6, or the hotel 110-7 illustrated in FIG. 1.

In the diagram 200, an access provider 205 (one example of the access providers 120 of FIG. 1) transmits a beacon 220 announcing one or more requirements for connecting the client device 105 to the access provider 205. The beacon 220 may be implemented in any suitable form, such as an IEEE 802.11u beacon. In some embodiments, the beacon 220 indicates that the client device 105 must provide a private identification for the user. In other embodiments, the beacon 220 indicates that the client device 105 must provide only a public identification.

The client device 105 attaches 225 to the access provider 205 responsive to the beacon 220 (that is, the client device 105 establishes a connection with the access provider 205), and the access provider 205 begins authentication of the user, e.g., via the Extensible Authentication Protocol (EAP) process, by communicating one or more acceptable credential types 230 to the client device 105. The client device 105 may search a list of profiles stored thereon and may automatically select an identity 235 corresponding to an acceptable credential type 230 (e.g., a token, certificate, username/password, SIM, etc.) and that best matches the one or more requirements that had been specified by the access provider 205 (e.g., via the beacon 220). In some embodiments, the identity 235 comprises elements of a Uniform Resource Locator (URL), such as a domain name. The client device 105 may select a best match using any suitable techniques.

The client device 105 provides the selected identity 235 to the access provider 205, and the access provider 205 contacts a Domain Name Service (DNS) server 210 using the identity 235. As shown in the diagram 200, the identity 235 selected by the client device 105 is “bob@newco.com”, which may be a public identity or a private identity responsive on the beacon 220 transmitted by the access provider 205. The access provider 205 looks up 240 “newco.com” with the DNS server 210. Using the result from the DNS server 210, the access provider 205 sets up an encrypted and authenticated Transport Layer Security (TLS) tunnel 245 to an identity provider 215 (one example of the identity providers 130 of FIG. 1) corresponding to the selected identity 235. The identity provider 215 provides an EAP authorization 250 using Remote Authentication Dial In User Service (RADIUS) attributes to the access provider 205, and the access provider 205 provides an EAP authorization 255 to the client device 105 using EAP over LANs (EAPoL).

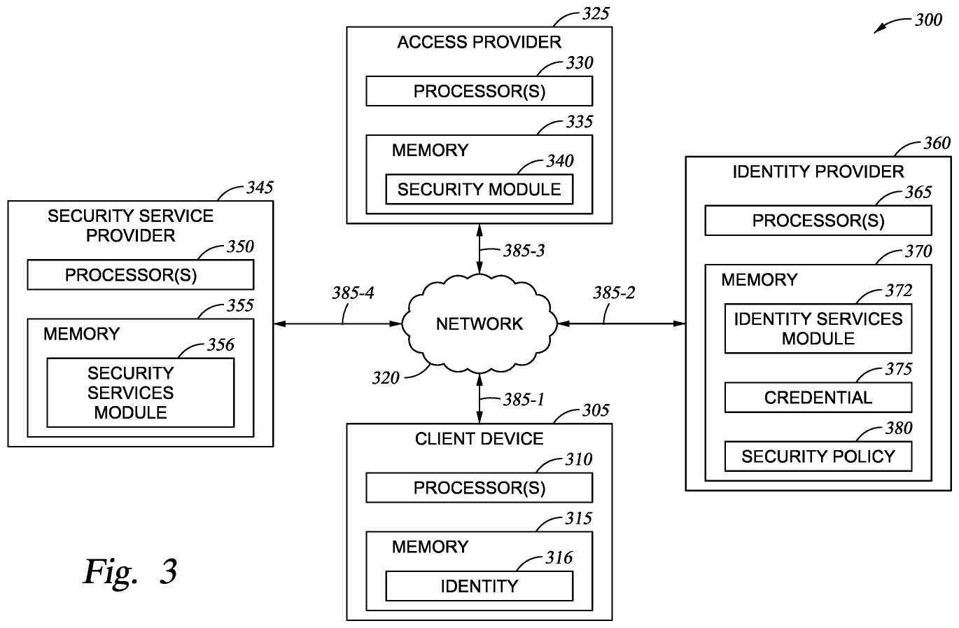

FIG. 3 is a diagram 300 illustrating accessing a network-based security service, according to one or more embodiments. The features illustrated in the diagram 300 may be used in conjunction with other embodiments. For example, the client device 305, the access provider 325, and the identity provider 360 of FIG. 3 may be respective examples of the client device 105, the access providers 120, and the identity providers 130 of FIG. 1.

In the diagram 300, the client device 305, the access provider 325, the identity provider 360, and a security service provider 345 are connected to a network 320 via respective communicative links 385-1, 385-3, 385-2, 385-4. Each of the client device 305, the access provider 325, the identity provider 360, and the security service provider 345 may be respectively implemented as one or more computing devices in any suitable form(s). For example, the client device 305 may be implemented as a mobile computing device of a user, while the access provider 325, the identity provider 360, and the security service provider 345 may be implemented as server computers.

Each of the client device 305, the access provider 325, the identity provider 360, and the security service provider 345 comprises a respective one or more computer processors 310, 330, 365, 350 and a respective memory 315, 335, 370, 355. The one or more computer processors 310, 330, 365, 350 may be implemented in any suitable form, such as a general purpose microprocessor, a controller, an application-specific integrated circuit (ASIC), and so forth. The memory 315, 335, 370, 355 may include a variety of computer-readable media selected for their size, relative performance, or other capabilities: volatile and/or non-volatile media, removable and/or non-removable media, etc.

The network 320 (one example of the federation-based network 115 of FIG. 1) represents one or more networks of any suitable types, such as the Internet, a local area network (LAN), a wide area network (WAN), and/or a wireless network. The communicative links 385-1, 385-2, 385-3, 385-4 to the network 320 may have any suitable implementation, such as copper transmission cable(s), optical transmission fiber(s), wireless transmission, router(s), firewall(s), switch(es), gateway computer(s), and/or edge server(s).

The memory 315, 335, 355, 370 may include one or more modules for performing various functions described herein. In one embodiment, each module includes program code that is executable by the one or more computer processors 310, 330, 350, 365. In another embodiment, each module is partially or fully implemented in hardware (i.e., circuitry) or firmware of the client device 305, the access provider 325, the identity provider 360, and the security service provider 345 (e.g., as circuitry within the one or more computer processors 310, 330, 365, 350). However, other embodiments of the diagram 300 may include modules that are partially or fully implemented in other hardware or firmware, such as hardware or firmware included in one or more other computing devices connected with the network 320, and so forth. Stated another way, the overall functionality of the one or more modules may be distributed among other devices of the diagram 300.

As shown, the memory 335 of the access provider 325 comprises a security module 340, the memory 355 of the security service provider 345 comprises a security services module 356, and the memory 370 of the identity provider 360 comprises an identity services module 372.

The security module 340 generally communicates with the client device 305, the identity provider 360, and the security service provider 345 to establish a secure connection with the security service provider 345 to provide one or more network-based security services for network traffic of the client device 305.

The security services module 356 generally provides the one or more network-based security services for network traffic. In some embodiments, the security services module 356 provides cloud-based security services using distributed and/or scalable computing resources that may be provisioned and/or released on-demand. The security services module 356 may be implemented in any suitable form, such as a secure internet or web gateway. The one or more network-based security services may be of any suitable type(s), such as a firewall, a content filter, anti-malware, protection against known malicious sites, and so forth.

The identity services module 372 generally operates to create, maintain, and/or manage identity information for users. The identity services module 372 may further provide authentication services using the network 320. In some embodiments, the identity services module 372 issues a credential 375 used for authenticating a user. The credential 375 may be implemented in any suitable form, such as a secure token that is unique for a particular session with the user. In some embodiments, the secure token comprises (i) a value provided by the identity provider 360, (ii) an identifier of the identity provider 360, and/or (iii) a value provided by the security service provider 345. For example, the secure token may be implemented as a concatenation of (i), (ii), and (iii).

Each user is associated with one or more identities 316. In some embodiments, the user configures one or more security policies 380 corresponding to the one or more identities 316, and the one or more security policies 380 are stored with the identity provider 360. Thus, the one or more security policies 380 may be predefined relative to when the client device 305 roams. Each security policy 380 specifies one or more security services (or security capabilities or features) to be applied when the corresponding identity 316 is selected. In some embodiments, the security policies 380 may specify a particular security service provider 345 to use, may specify a preferred order for selecting the security service provider 345, and so forth. Each security policy 380 may be stored in any suitable format, such as YAML, XML, and so forth.

Thus, the identity provider 360 may be capable of offering cloud-based security services when the user roams to a capable access provider 325. For example, the identity provider 360 may have a revenue sharing agreement with one or more security service providers 345. In some embodiments, the identity provider 360 may offer multiple levels or tiers of security that are selectable by the user.

Each of the identities 316 associated with the user may be associated with a set of one or more cloud-based security services. The identities 316 may be sorted or prioritized based on user preferences. Further, the cloud-based security services may be selected and/or purchased directly by the user, or may be offered directly by the access provider 325.

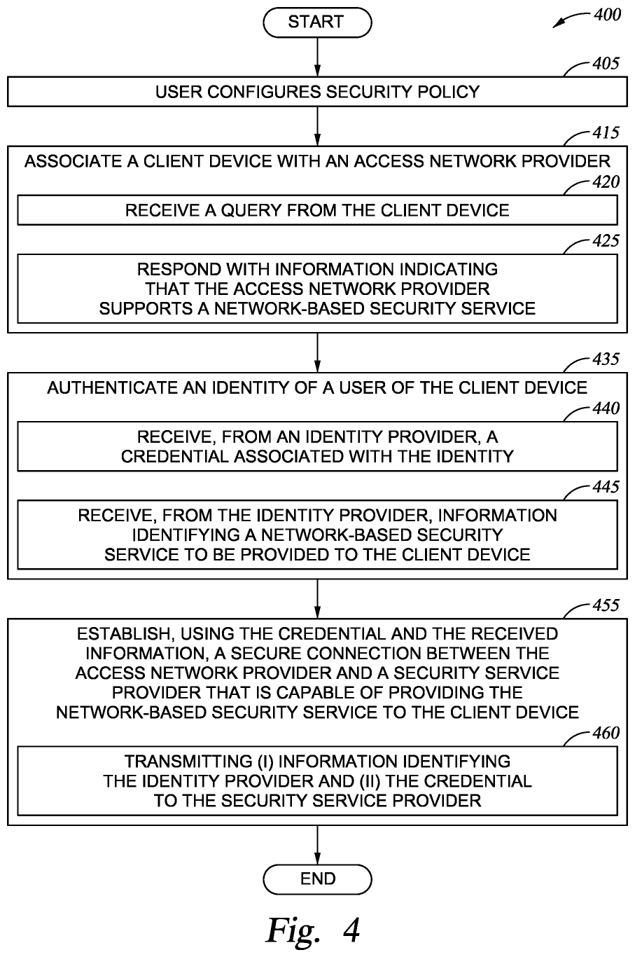

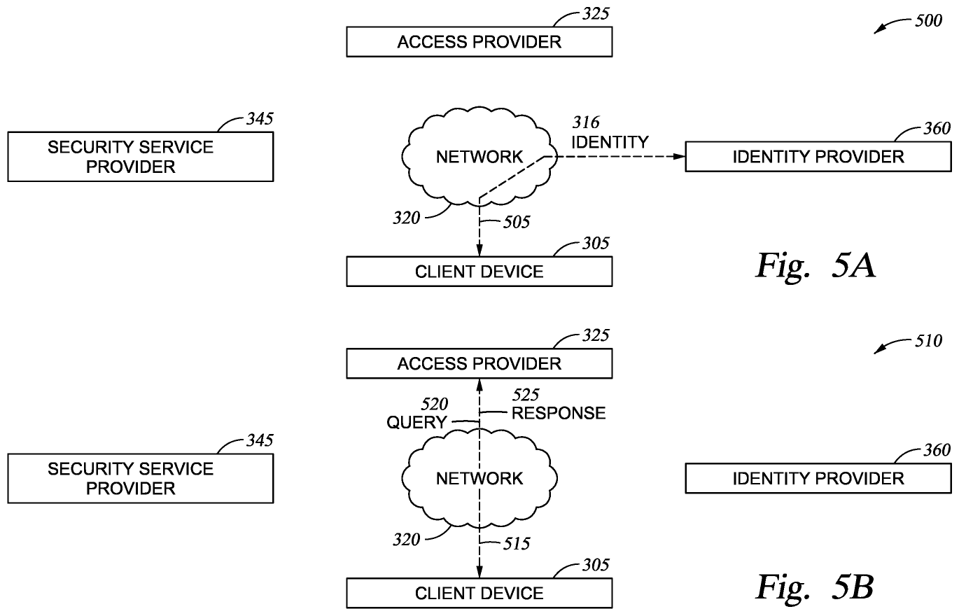

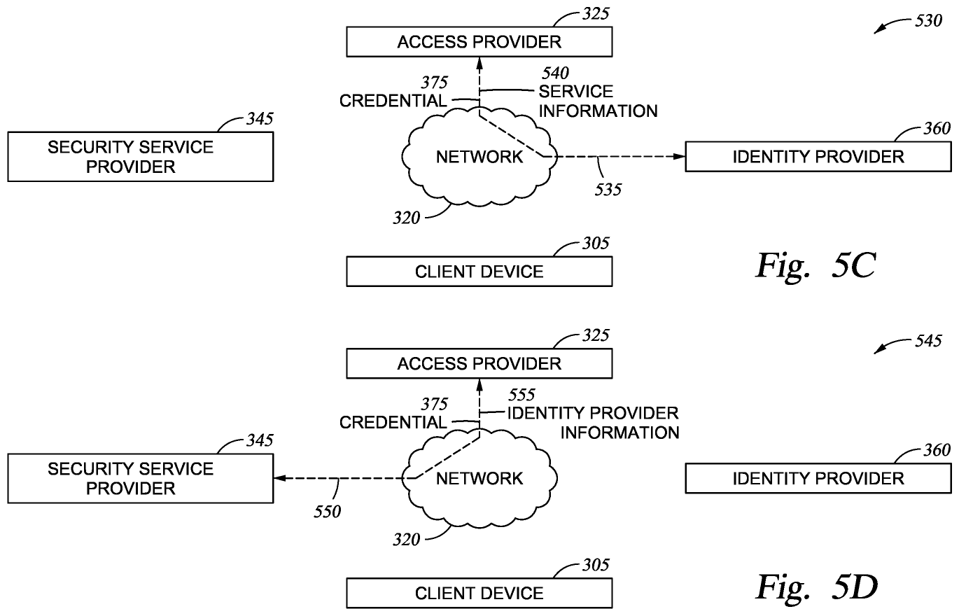

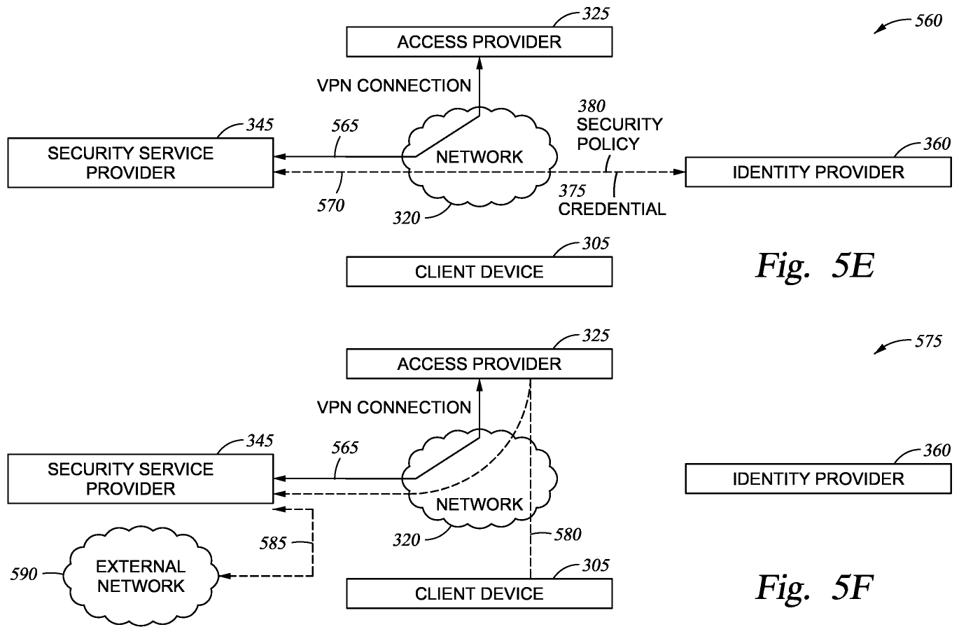

FIG. 4 is a method 400 of accessing a network-based security service, according to one or more embodiments. The method 400 may be used in conjunction with other embodiments. For example, the method 400 may be performed by the security module 340 of FIG. 3. Further, the method 400 will be described in conjunction with diagrams 500, 510, 530, 545, 560, 575 of FIGS. 5A-5F.

The method 400 begins at block 405, where a user configures a security policy. In some embodiments, the security policy specifies one or more security services to be applied when a particular identity associated with the user is selected. The security policy may be stored with the identity provider.

In the diagram 500 of FIG. 5A, the user operates the client device 305 to configure the security policy. In some alternate implementations, the user may use another computing device to configure the security policy. As shown, the client device 305 communicates with the identity provider 360 through the network 320 (that is, communications 505) to specify the one or more security services for the security policy. The security policy is associated with the identity 316 and is stored with the identity provider 360.

In other embodiments, the user may associate the security services to roaming connections generally. This may be applicable where the identity provider does not offer security service(s), where the user purchases the security service(s) directly, or where the access provider offers the security service(s) directly. In other embodiments, the identity provider may be an enterprise and associates the security service(s) for the employees.

At block 415, a client device associates with an access network provider. In the diagram 510 of FIG. 5B, the client device 305 communicates with the access provider 325 through the network 320 (that is, communications 515) to determine whether the access network provider supports network-based security services.

In some embodiments, associating the client device comprises receiving a query from the client device at block 420, and responding with information indicating that the access network provider supports a network-based security service at block 425. In the diagram 510, the communications 515 comprise a query 520 and a response 525, which in some cases may be compliant with Access Network Query Protocol (ANQP).

In some embodiments, the client device 305 may preferentially connect to access network providers (e.g., the access provider 325) that support the security service for the security policy. In some embodiments, the access network provider may provide further information (e.g., advertising) that the access network provider supports the security service through the particular security service provider 345. The client device 305 may preferentially connect to access network providers (e.g., the access provider 325) based on the particular security service provider 345.

At block 435, the access provider authenticates an identity of a user of the client device. In some embodiments, authenticating the identity of the user comprises at block 440 receiving a credential associated with the identity from the identity provider, and at block 445 receiving information identifying a network-based security service to be provided to the client device from the identity provider.

In some embodiments, during the association process the access provider relays EAP traffic to the identity provider to permit the identity provider to verify the credential of the user. If the authentication by the access provider is successful, the identity provider returns instructions to the access provider, e.g., by RADIUS attributes in RadSec. The instructions inform the access provider that the user has subscribed to the security service.

In the diagram 530 of FIG. 5C, the access provider 325 communicates with the identity provider 360 through the network 320 (that is, communications 535). In the diagram 530, the communications 535 comprise the access provider 325 receiving the credential 375 for the user and service information 540 identifying a network-based security service to be provided to the client device 305. In some embodiments, the service information 540 further comprises specifying the security service provider 345 to be used to provide the network-based security service. For example, the service information 540 may include a network address (e.g., an anycast address) that identifies the security service provider 345, e.g., where the identity provider 360 and the security service provider 345 have a pre-existing and trusted relationship. In some embodiments, a plurality of security service providers 345 may be available to provide the network-based security service, and a RADIUS option dialog may be used to determine the security service provider 345 that is both accepted by the client device 305 and supported by the access provider 325.

At block 455, the access provider establishes, using the credential and the received information, a secure connection between the access provider and the security service provider that is capable of providing the network-based security service to the client device. In some embodiments, the secure connection comprises a virtual private network (VPN). In some embodiments, establishing the secure connection comprises (at block 460) transmitting (i) information identifying the identity provider and (ii) the credential to the security service provider. The method 400 ends following completion of the block 455.

In the diagram 545 of FIG. 5D, the access provider 325 communicates with the security service provider 345 through the network 320 (that is, communications 550). In the diagram 545, the communications 550 comprise the security service provider 345 receiving the credential 375 and identity provider information 555. The identity provider information 555 identifies the identity provider 360, and the credential 375 and the identity provider information 555 configure the security service provider 345 to retrieve, from the identity provider 360, a security policy for the identity.

In some embodiments, the access provider 325 receives a RADIUS Access-Accept response from the identity provider 360. The access provider 325 uses the service information 540 (e.g., the RADIUS attributes) to establish a secure connection to the security service provider 345. In some embodiments, the access provider 325 provides the security service provider 345 with the credential 375, and the identity provider information 555 indicates which identity provider 360 realm or domain that the user belongs to.

In the diagram 560 of FIG. 5E, a VPN connection 565 is established between the access provider 325 and the security service provider 345. In some embodiments, the security service provider 345 examines the request from the access provider 325, and communicates with the identity provider 360 through the network 320 (that is, communications 570).

The security service provider 345 contacts the identity provider 360 to retrieve the security policy 380 associated with the identity and/or the user. The identity provider 360 responds by challenging the security service provider 345 to provide the credential 375. The identity provider 360 returns the security policy 380 responsive to receiving the credential 375, which verifies the request from the access provider 325.

In some embodiments, on the access provider 325 the proxy isolates the traffic from the client device 305 and redirects it through the VPN connection 565, ensuring that all traffic originating from the client device 305, e.g., is transmitted through the cloud firewall. In the diagram 575 of FIG. 5F, the security service provider 345 receives the security policy 380 and applies the security service(s) specified by the security policy 380 to a connection 580 of the client device 305. In the diagram 575, the client device 305 connects to an external network 590 (e.g., the internet) via a connection 585 between the security service provider 345 and the external network 590, and the security service provider 345 applies the security service(s) to the connection 585.

In some embodiments, for future instances of the client device 305 roaming to the same access provider 325, the information used to apply the security service(s) may be cached to accelerate the connection process.

In some alternate embodiments, the identity provider 360 may, responsive to the successful authentication of the user, contact the security service provider 345 and provide the credential 375 prior to an incoming request from the access provider 325. In some embodiments, the credential 375 comprises a secure token implemented as a concatenation of a value provided by the identity provider 360, an identifier of the identity provider 360, and a value provided by the security service provider 345. The access provider 325 uses the credential 375 to establish the secure connection with the security service provider 345.

At the conclusion of the session, the access provider 325 and/or the security service provider 345 may collect logs of the transaction, which may be shared with the identity provider 360.

In some alternate embodiments, the security service(s) may be provided directly by the access provider 325, e.g., responsive to determining that none of the identities of the user support the security service(s). For example, following the query from the client device (e.g., block 420 of the method 400) and successful authentication (without the identity provider 360 specifying the security service provider 345), the access provider 325 uses the advice of charge ANQP message to suggest the security service(s) to the user, which in some cases may also specify different security service provider(s) and/or options. Responsive to receiving the user selection of a security service provider 345 and one or more security services, the access provider 325 establishes the secure tunnel as in block 455 of the method 400.

In these embodiments, the access provider 325 is responsible to generate the VPN credentials for the user, which in some cases may be a token associated to the advice of charge communicated to the user over ANQP. The client device 305 stores the token matching the charge for that session, which can then be verified against the security service provider 345 and the accounting database for the access provider 325.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

pow The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
authenticating an identity of a user of a client device associated with an access network provider, wherein authenticating the identity of the user comprises:
receiving, from an identity provider, a credential associated with the identity; and
receiving, from the identity provider, information identifying a network-based security service to be provided to the client device; and
establishing, using the credential and the received information, a secure connection between the access network provider and a security service provider that is capable of providing the network-based security service to the client device.

2. The method of claim 1, wherein the network-based security service is specified in a security policy for the identity that is stored by the identity provider.

3. The method of claim 1, wherein associating the client device comprises:
receiving a query from the client device; and
responding with information indicating that the access network provider supports the network-based security service.

4. The method of claim 3, wherein the information further indicates that the access network provider supports the network-based security service through the security service provider.

5. The method of claim 1, wherein establishing the secure connection comprises:
transmitting (i) information identifying the identity provider and (ii) the credential to the security service provider,
wherein transmitting (i) and (ii) configures the security service provider to retrieve, from the identity provider, a security policy for the identity.

6. The method of claim 1, wherein the information identifying the network-based security service further comprises a network address of the security service provider.

7. The method of claim 1, wherein the credential is a secure token comprising a value provided by the identity provider, an identifier of the identity provider, and a value provided by the security service provider.

8. A network device comprising:
one or more computer processors configured to perform an operation comprising:
authenticating an identity of a user of a client device associated with an access network provider, wherein authenticating the identity of the user comprises:
receiving, from an identity provider, a credential associated with the identity; and
receiving, from the identity provider, information identifying a network-based security service to be provided to the client device; and
establishing, using the credential and the received information, a secure connection between the access network provider and a security service provider that is capable of providing the network-based security service to the client device.

9. The network device of claim 8, wherein the network-based security service is specified in a security policy for the identity that is stored by the identity provider.

10. The network device of claim 8, wherein associating the client device comprises:
receiving a query from the client device; and
responding with information indicating that the access network provider supports the network-based security service.

11. The network device of claim 10, wherein the information further indicates that the access network provider supports the network-based security service through the security service provider.

12. The network device of claim 8, wherein establishing the secure connection comprises:
transmitting (i) information identifying the identity provider and (ii) the credential to the security service provider,
wherein transmitting (i) and (ii) configures the security service provider to retrieve, from the identity provider, a security policy for the identity.

13. The network device of claim 8, wherein the information identifying the network-based security service comprises a network address of the security service provider.

14. The network device of claim 8, wherein the credential is a secure token comprising a value provided by the identity provider, an identifier of the identity provider, and a value provided by the security service provider.

15. A computer program product comprising:
a computer-readable storage medium having computer-readable program code embodied therewith, the computer-readable program code executable by one or more computer processors to perform an operation comprising:
authenticating an identity of a user of a client device associated with an access network provider, wherein authenticating the identity of the user comprises:
receiving, from an identity provider, a credential associated with the identity; and
receiving, from the identity provider, information identifying a network-based security service to be provided to the client device; and
establishing, using the credential and the received information, a secure connection between the access network provider and a security service provider that is capable of providing the network-based security service to the client device.

16. The computer program product of claim 15, wherein the network-based security service is specified in a security policy for the identity that is stored by the identity provider.

17. The computer program product of claim 15, wherein associating the client device comprises:
receiving a query from the client device; and
responding with information indicating that the access network provider supports the network-based security service.

18. The computer program product of claim 17, wherein the information further indicates that the access network provider supports the network-based security service through the security service provider.

19. The computer program product of claim 15, wherein establishing the secure connection comprises:
transmitting (i) information identifying the identity provider and (ii) the credential to the security service provider,
wherein transmitting (i) and (ii) configures the security service provider to retrieve, from the identity provider, a security policy for the identity.

20. The computer program product of claim 15, wherein the information identifying the network-based security service further comprises a network address of the security service provider.
